(19) United States
(12) Patent Application Publication
(10) Pub. No.: US 2025/0389141 A1
(43) Pub. Date: Dec. 25, 2025

(54) VEHICLE STRIKER ASSEMBLY

(71) Applicant: FORD GLOBAL TECHNOLOGIES, LLC, Dearborn, MI (US)

(72) Inventors: Collin Meister, Canton, MI (US); Constantin Manolescu, Dearborn, MI (US)

(21) Appl. No.: 18/747,846

(22) Filed: Jun. 19, 2024

(51) Int. Cl. E05B 85/04; E05B 83/24

(52) U.S. Cl. CPC E05B 85/04; E05B 83/243

(57) ABSTRACT

A device may include a striker assembly including a foldable striker that pivots about a striker axis from a deployed position to a folded position in response to movement of a closure module from a closed position to an open position.

### TECHNICAL FIELD

This disclosure relates generally to striker assemblies of vehicles and, more particularly, to striker assemblies that include a foldable striker.

### BACKGROUND

Vehicles closure modules typically utilize a striker and a latch mechanism to hold the closure module in a closed position. The striker engages with the latch mechanism, which locks it in place, to hold the closure module in the closed position.

### SUMMARY

In some aspects, the techniques described herein relate to a vehicle assembly, including: a striker assembly including a foldable striker that pivots about a striker axis from a deployed position to a folded position in response to movement of a closure module from a closed position to an open position.

In some aspects, the techniques described herein relate to a vehicle assembly, further including a biasing member that biases the foldable striker to the deployed position.

In some aspects, the techniques described herein relate to a vehicle assembly, further including an actuation cable configured to move the foldable striker from the deployed position to the folded position in response to the closure module moving from the closed position to the open position.

In some aspects, the techniques described herein relate to a vehicle assembly, further including a striker cable cam, the actuation cable coupled to the striker assembly through the striker cable cam.

In some aspects, the techniques described herein relate to a vehicle assembly, wherein the striker cable cam includes a body that rotates about the striker axis, and a stop that projects radially outward from the body, the stop configured to block rotation of the foldable striker past the deployed position.

In some aspects, the techniques described herein relate to a vehicle assembly, further including a hinge assembly including a hinge cable cam, wherein a first end of the actuation cable is coupled to the striker cable cam and an opposite, second end of the actuation cable is coupled to the hinge cable cam.

In some aspects, the techniques described herein relate to a vehicle assembly, wherein the hinge assembly includes an upper hinge and a lower hinge that pivot about a hinge axis, and the hinge cable cam includes a body and a post that projects laterally from the body and connects the upper hinge and the lower hinge, the post secured to the upper hinge such that the hinge cable cam pivots with the upper hinge about the hinge axis.

In some aspects, the techniques described herein relate to a vehicle assembly, further including the closure module, wherein the hinge cable cam rotates about the hinge axis to move the actuation cable in a first direction to cause the foldable striker to pivot from the deployed position to the folded position when the closure module moves from the closed position to the open position.

In some aspects, the techniques described herein relate to a vehicle assembly, wherein, when the foldable striker is in the deployed position, the foldable striker extends perpendicularly away from the closure module, and when the foldable striker is in the folded position, the foldable striker is folded against the closure module.

In some aspects, the techniques described herein relate to a vehicle assembly, wherein the closure module is a hood.

In some aspects, the techniques described herein relate to a vehicle assembly, including: a closure module of a vehicle, the closure module moveable between a closed position and an open position; a striker assembly secured to the closure module at a first location, the striker assembly including a foldable striker that pivots about a striker axis from a deployed position to a folded position when the closure module moves from the closed position to the open position; a hinge assembly secured to the closure module at a second location; and an actuation cable that operably couples the striker assembly to the hinge assembly.

In some aspects, the techniques described herein relate to a vehicle assembly, wherein, when the closure module is moved from the closed position to the open position, the hinge assembly moves the actuation cable in a first direction to cause the foldable striker to pivot from the deployed position to the folded position.

In some aspects, the techniques described herein relate to a vehicle assembly, further including a biasing member that biases the foldable striker from the folded position to the deployed position when the closure module is moved from the open position to the closed position.

In some aspects, the techniques described herein relate to a vehicle assembly, wherein the striker assembly includes a striker cable cam that is coupled to the actuation cable.

In some aspects, the techniques described herein relate to a vehicle assembly, wherein the hinge assembly includes an upper hinge that is secured at the second location to the closure module, a lower hinge that is secured to a body side panel of the vehicle, and a hinge cable cam that pivots about a hinge axis and connects the upper hinge and the lower hinge.

In some aspects, the techniques described herein relate to a vehicle assembly, wherein the hinge cable cam is coupled to the actuation cable.

In some aspects, the techniques described herein relate to a vehicle striker actuation method, including: folding a foldable striker of a striker assembly in response to moving a closure module of a vehicle from a closed position to an open position.

In some aspects, the techniques described herein relate to a method, wherein moving the closure module from the closed position to the open position moves an actuation cable in a first direction to cause the foldable striker to pivot from a deployed position to a folded position.

In some aspects, the techniques described herein relate to a method, further including biasing the foldable striker to cause the foldable striker to pivot from the folded position to the deployed position in response to moving the closure module from the open position to the closed position.

In some aspects, the techniques described herein relate to a method, wherein the closure module is a hood.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a vehicle including a closure module in a closed position.

FIG. 2 illustrates the vehicle of FIG. 1 with the closure module in an open position.

FIG. 3 illustrates a perspective view of a closure module removed from a vehicle to show a foldable striker system including a striker assembly, a hinge assembly, and an actuation cable according to an exemplary aspect of the present disclosure.

FIG. 4 illustrates a perspective view of the striker assembly of FIG. 3 including a foldable striker of the striker assembly with the foldable striker in a deployed position.

FIG. 5 illustrates another perspective view of the striker assembly of FIG. 3.

FIG. 6 is a close-up view of a portion of the striker assembly of FIG. 3.

FIG. 7 is another close-up view of a portion of the striker assembly of FIG. 3.

FIG. 8 illustrates a perspective view of the foldable striker in a folded position.

FIG. 9 illustrates a perspective view of a hinge assembly of FIG. 3 in a first position.

FIG. 10 illustrates another perspective view of the hinge assembly of FIG. 3

FIG. 11 illustrates a perspective view of the hinge assembly of FIG. 3 in a second position.

### DETAILED DESCRIPTION

This disclosure relates generally to a striker assembly that can be used to hold a closure module, such as a vehicle hood, in a closed position. In an example, the foldable striker pivots about a striker axis from a deployed position to a folded position in response to moving a closure module from a closed position to an open position. Moving the foldable striker to the folded position can provide clearance for accessing areas of a vehicle. These and other features are discussed in greater detail in the following paragraphs of this detailed description.

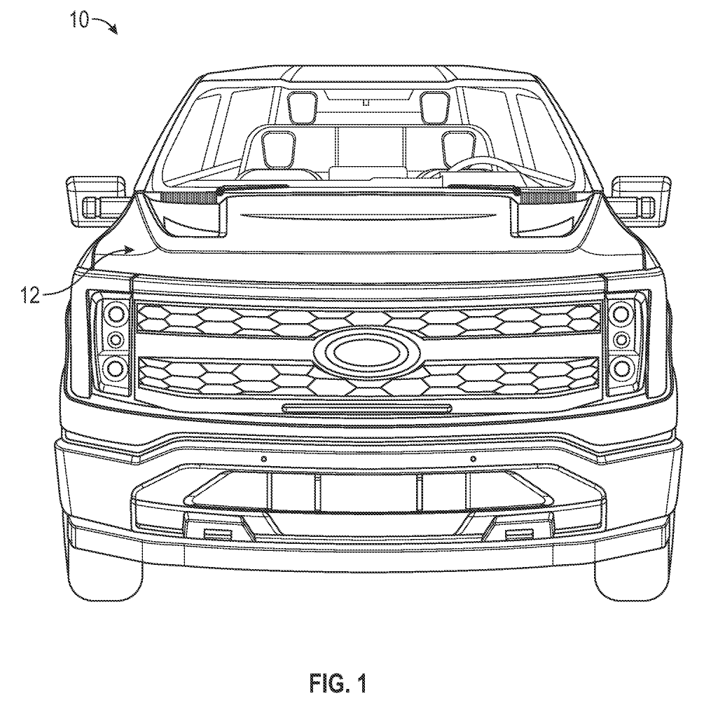

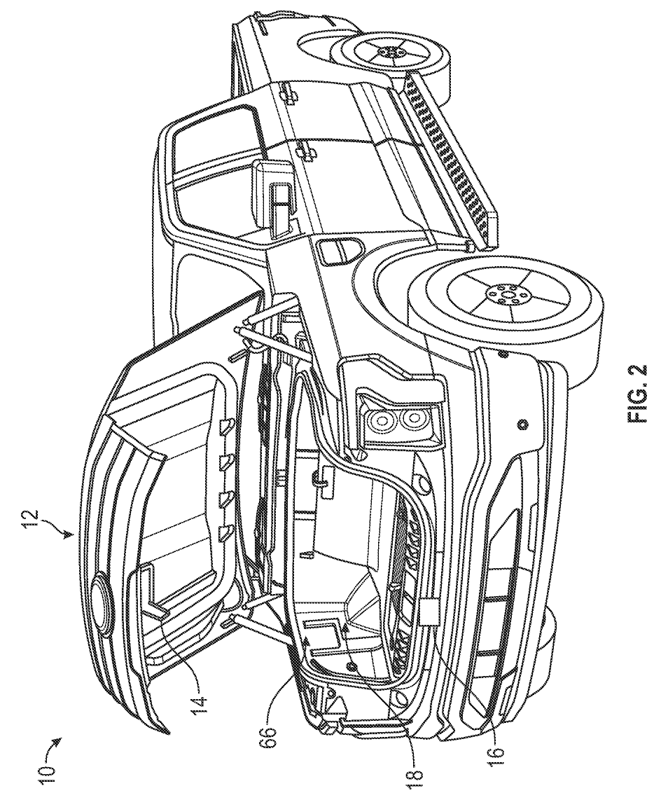

FIGS. 1 and 2 illustrate a vehicle 10. Although a specific component relationship is illustrated in the figures of this disclosure, the illustrations are not intended to limit this disclosure. The placement and orientation of the various components of the vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the exemplary embodiment, the vehicle 10 is a pickup truck. However, the vehicle 10 could alternatively be a car, a van, a sports utility vehicle (SUV), or any other vehicle configuration.

The vehicle 10 includes a closure module 12, a striker assembly 14, and a latch mechanism 16. The closure module 12 is a hood in this example. In another example, the closure module 12 could be a door, tailgate, trunk lid, glovebox lid, center console lid, storage tunnel lid, or any other type of closure module configuration.

The closure module 12 can move between a closed position (FIG. 1) and an open position (FIG. 2). When in the closed position, the closure module 12 provides a barrier between the interior and exterior of the vehicle 10. When in the open position, the closure module 12 permits users to access a compartment, here a frunk 18 of the vehicle 10. While the examples of this disclosure are described in connection with the frunk 18, the examples could be used in connection with other compartments, such as an engine compartment.

The striker assembly 14 and the latch mechanism 16 are configured to engage to hold the closure module 12 in the closed position. The striker assembly 14 is secured to the underside of the closure module 12. The latch mechanism 16 is arranged within the vehicle body near a front end of the compartment 18. When in the closed position, the latch mechanism 16 engages the striker assembly 14 to hold the closure module 12 in the closed position. In this example, pulling a release lever inside the vehicle 10 disengages the latch mechanism 16 from the striker assembly 14 to allow the closure module 12 to move to the open position.

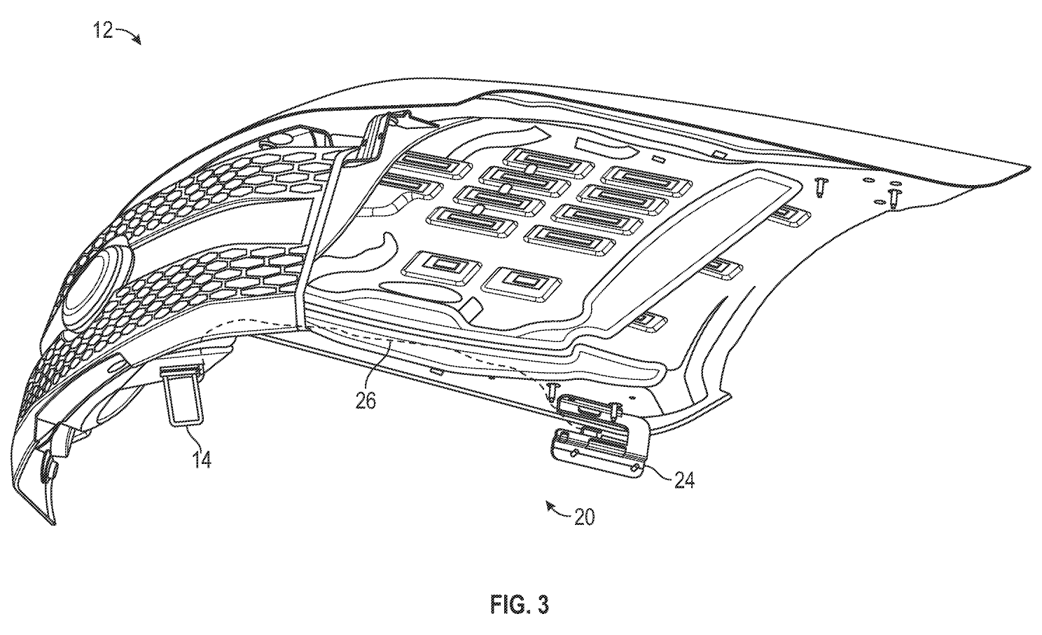

FIG. 3 illustrates a foldable striker system 20 of the vehicle 10 of FIG. 1, which includes the striker assembly 14, a hinge assembly 24, and an actuation cable 26 that is operably coupled to the striker assembly 14 and the hinge assembly 24. The striker assembly 14 is secured at a first location on a forward side of the closure module 12. The striker assembly 14 could be secured at another location on the closure module 12 in other examples. The hinge assembly 24 is secured at a second location on a lateral side of the closure module 12. The actuation cable 26 (indicated in dashed lines for illustrative purposes) is routed through the closure module 12 between the striker assembly 14 and the hinge assembly 24. In one example, the actuation cable 26 is fastened (e.g., clipped) to the closure module 12.

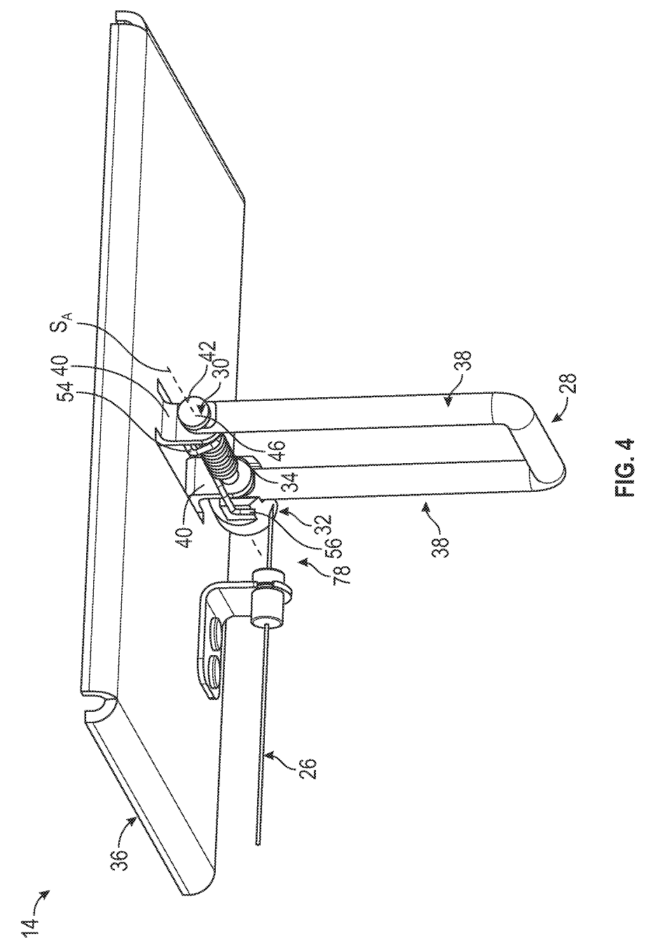

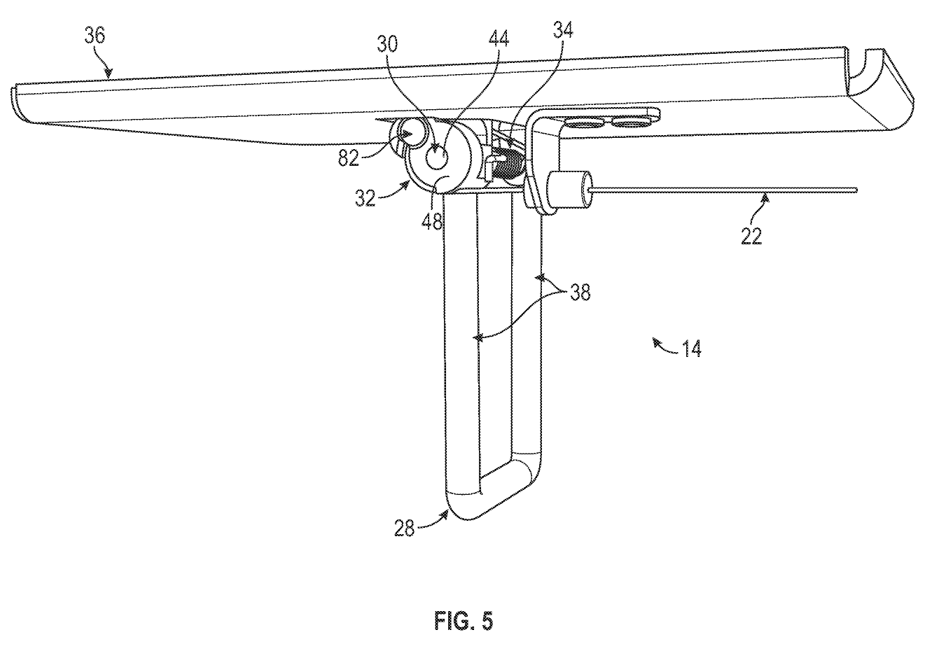

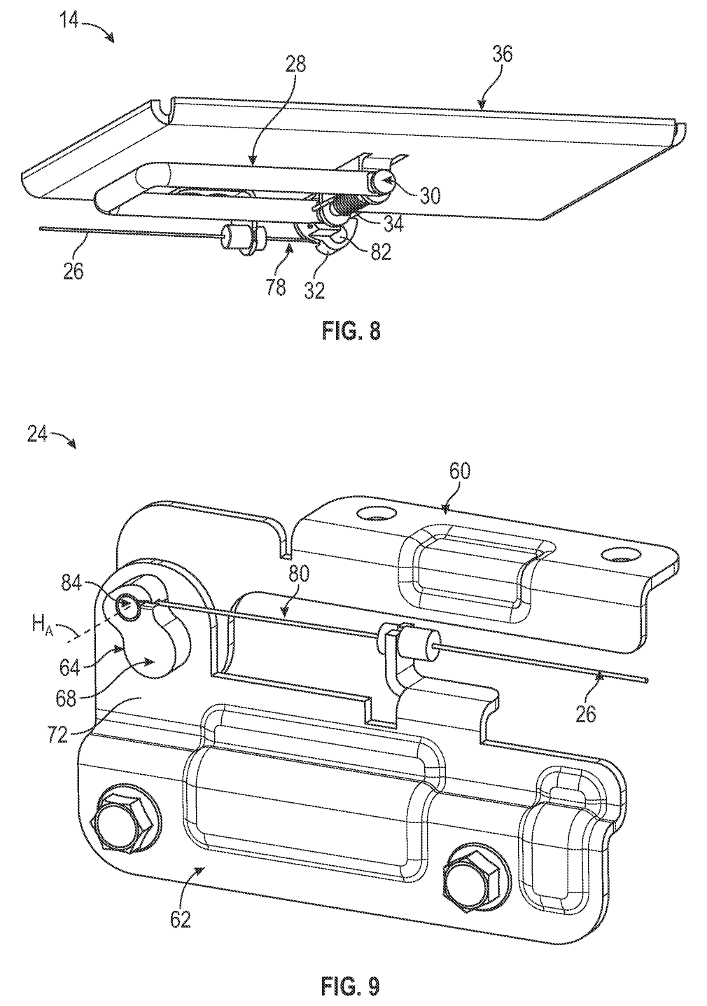

With reference to FIGS. 4–8, the striker assembly 14 includes a foldable striker 28, a striker pin 30, a striker cable cam 32, and a biasing member 34. The foldable striker 28 is pivotable about a striker axis S_{A} from a deployed position (FIG. 4) to a folded position (FIG. 8) in response to moving the closure module 12 from a closed position to an open position. When in the deployed position, the foldable striker 28 extends perpendicularly away from the closure module 12. When in the folded position, the foldable striker 28 is folded against the closure module 12 providing clearance for a user to access the frunk.

The foldable striker 28, while in the deployed position, is engageable with a latch mechanism, such as the latch mechanism 16 (see FIG. 2) to hold the closure module 12 in the closed position.

The foldable striker 28 is pivotably supported on a reinforcement bracket 36. The foldable striker 28 is generally U-shaped and includes a pair of opposing legs 38 that are pivotably coupled to the striker pin 30. The foldable striker 28 could have other shapes within the scope of this disclosure. The legs 38 provide pivot points for coupling to the striker pin 30. The striker pin 30 is generally cylindrical and provides the striker axis S_{A} around which the foldable striker 28 pivots. In this example, the reinforcement bracket 36 includes a pair of opposing arms 40 which support the striker pin 30. The striker pin 30 extends through respective holes in the legs 38 of the foldable striker 28, the arms 40 of the reinforcement bracket 36, and the striker cable cam 32. The reinforcement bracket 36 can be secured to the closure module 12 to support the striker assembly 14 at the first location.

The striker pin 30 is pivotably coupled to the foldable striker 28 and the striker cable cam 32. The striker pin 30 extends between a first end 42 and an opposite, second end 44. In the illustrated example, the first end 42 is coupled to one of the legs 38 of the foldable striker 28, and the second end 44 is coupled to the hinge cable cam 32. With this configuration, the foldable striker 28, the striker pin 30, and the striker cable cam 32 can pivot or otherwise rotate in unison about the striker axis S_{A}.

In this example, one of the legs 38 of the foldable striker 28 is sandwiched between an end cap 46 on the first end 42 of the striker pin 30 and one of the arms 40 of the reinforcement bracket 36, and a different one of the legs 38 is sandwiched between a different one of the arms 40 and the striker cable cam 32 to limit lateral movement of the foldable striker 28. The end cap 46 can be integrally formed or otherwise secured to the first end 42.

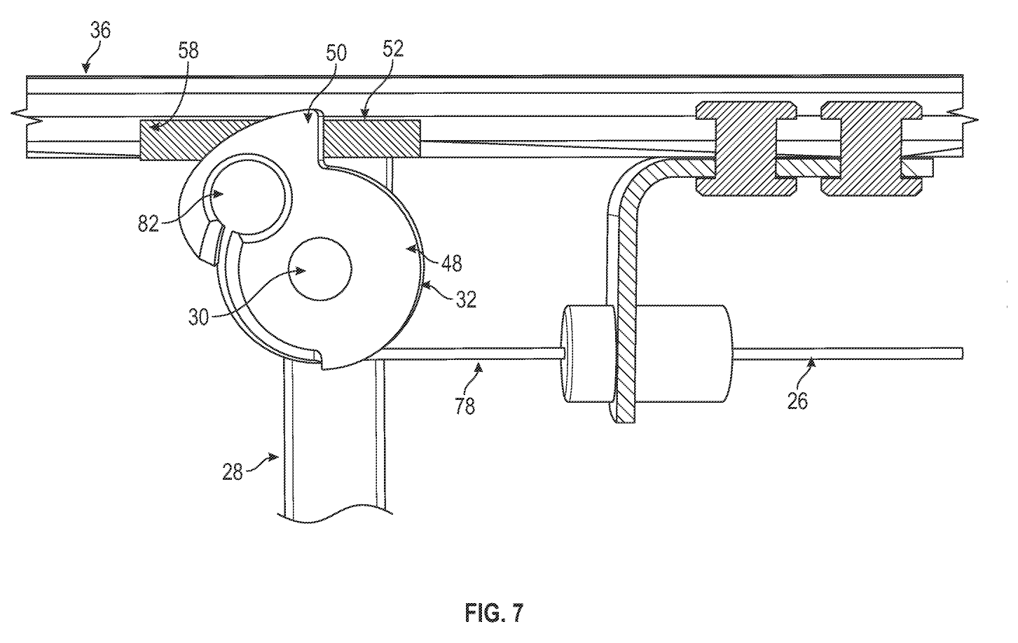

The striker cable cam 32 is configured to control movement of the foldable striker 28. With reference to FIG. 7, the striker cable cam 32 includes a body 48 and a stop 50. The body 48 is pivotably coupled to the foldable striker 28 via the striker pin 30 and rotates the striker cable cam 32 about the striker axis S_{A}. The stop 50 projects radially outward from the body 48. The stop 50 is configured to block the foldable striker 28 from pivoting past the deployed position. In one example, the stop 50 engages against a wall 52 formed in the reinforcement bracket 36 when the foldable striker 28 is in the deployed position. As discussed further below, the striker cable cam 32 is operably coupled to the actuation cable 26.

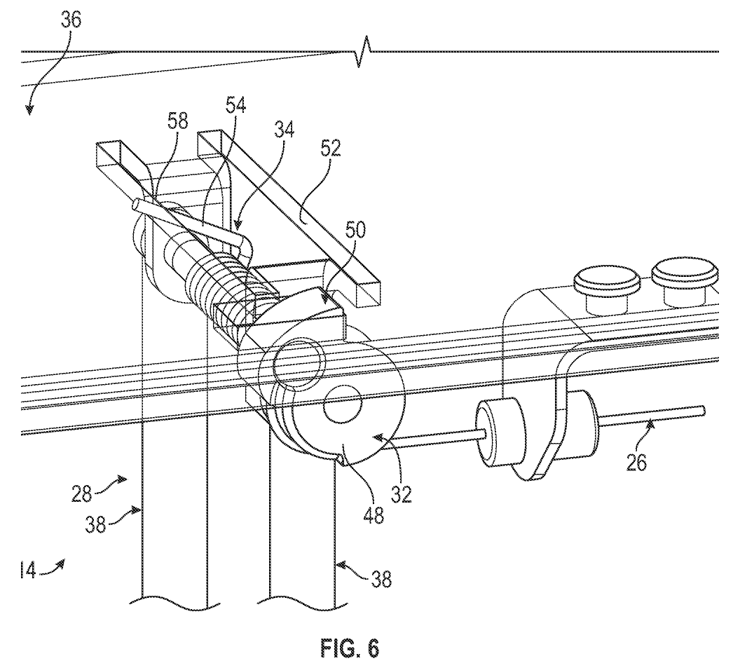

The biasing member (e.g., torsion spring) 34 is configured to bias the foldable striker 28 to the deployed position. The biasing member 34 includes a first end 54 and an opposite, second end 56 that are supported (e.g., coiled) on the striker pin 30. The first end 54 is engaged against a wall 58 formed in the reinforcement bracket 36 (see FIG. 6). The second end 56 is engaged against the striker cable cam 32 (see FIG. 4). Because the first end 54 engages with the wall 58, which is fixed, the second end 56 applies a biasing force on the striker cam 32 to bias the foldable striker 28 to the deployed position. The biasing member 34 biases the stop 50 of the striker cable cam 32 against the wall 52 of the reinforcement bracket 36 when the foldable striker 28 is in the deployed position. Although the biasing member 34 is shown as a spring in this example, the biasing member 34 could be any other type of biasing member.

In another example, the biasing force is reversed such that the biasing member 34 biases the foldable striker 28 to the folded position. In such an example, when the closure module 12 is moved from the open position to the closed position, the actuation cable 26 moves in a first direction to cause the foldable striker 28 to pivot from the folded position to the deployed position.

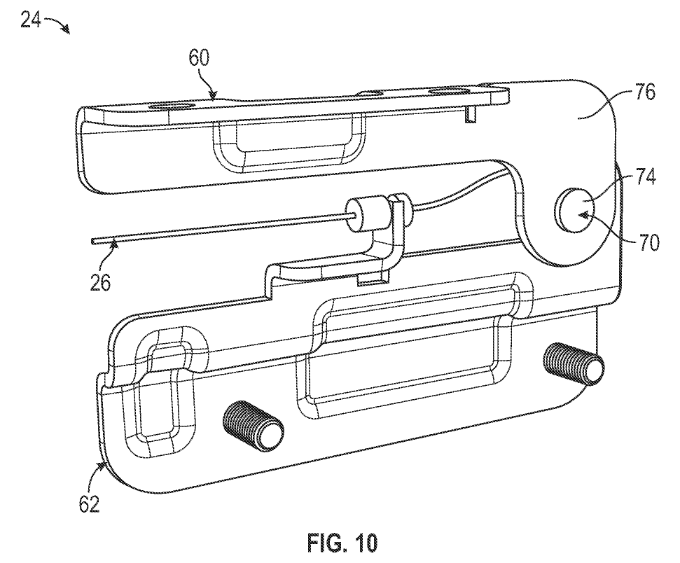

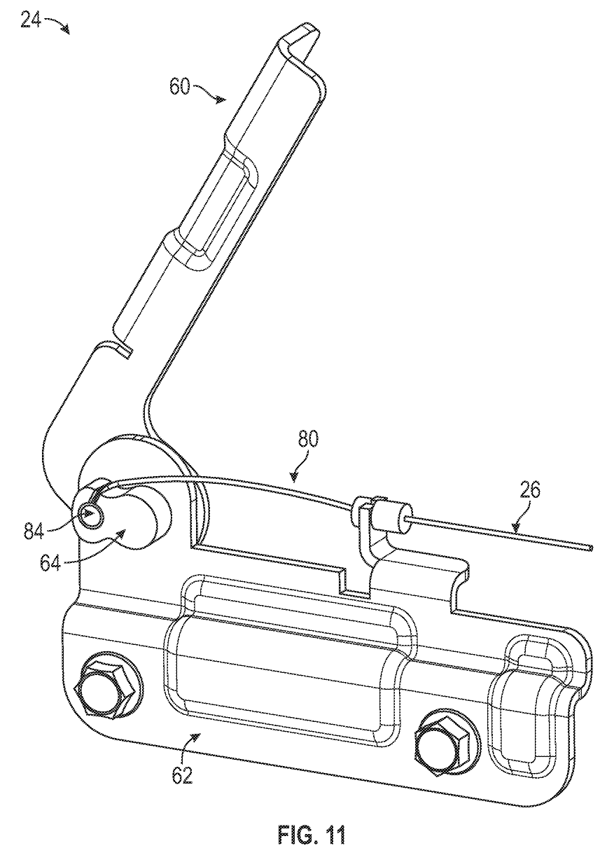

With reference to FIGS. 9–11, the example hinge assembly 24 includes an upper hinge 60, a lower hinge 62, and a hinge cable cam 64. The hinge assembly 24 is pivotable about a hinge axis H_{A} between a first position (FIG. 9) and a second position (FIG. 10) in response to moving the closure module 12 from a closed position to an open position. Various terms such as “upper,” “lower,” “inner,” and “outer” are used relative to the arrangement of the components of the foldable striker system 20 in the various drawings and should not otherwise be deemed limiting. These terms are with reference to the general orientation of the foldable striker system 20 when secured to the vehicle 10 of FIG. 1.

The upper hinge 60 is securable to the closure module 12. The lower hinge 62 is securable to a body side panel 66 of the vehicle 10 near a corner of the compartment 18 (see FIG. 2).

The hinge cable cam 64 includes a body 68 and a post 70 that projects laterally from the body 68 and connects the upper hinge 60 and the lower hinge 62. The body 68 abuts an outer face 72 of the lower hinge 62. The post 70 projects through respective openings in the upper hinge 60 and the lower hinge 62, and provides the hinge axis H_{A} around which the hinge assembly 24 pivots. An end portion 74 of the post 70 extends at least partially past an inner face 76 of the upper hinge 60. The end portion 74 can be secured (e.g., welded, soldered, etc.) to the inner face 76 such that the hinge cable cam 62 pivots or otherwise rotates with the upper hinge 60 about the hinge axis H_{A}.

The actuation cable 26 extends between a first end 78 and an opposite, second end 80. The first end 78 is coupled to the striker assembly 14 through the striker cable cam 32. A pin 82 is provided on the first end 78. The pin 82 is supported within a hole formed in the body 48 of the striker cable cam 32 to provide a connection between striker assembly 14 and the actuation cable 26.

The second end 80 is coupled to the hinge assembly 24 through the hinge cable cam 64. A pin 84 is provided on the second end 80. The pin 84 is supported within a hole formed in the body 68 of the hinge cable cam 64 to provide a connection between the hinge assembly 24 and the actuation cable 26.

The actuation cable 26 is configured to move the foldable striker 28 from the deployed position to the folded position in response to the closure module 12 moving from the closed position to the open position. When the closure module 12 is moved to the open position, the hinge assembly 24 pivots from the first position (FIG. 9) to the second position (FIG. 11), which causes the upper hinge 60 and the hinge cable cam 64 to pivot or otherwise rotate about the hinge axis H_{A} to pull or otherwise move the actuation cable 26 in a first direction toward the hinge assembly 24. The pulling force acting on the actuation cable 26 is greater than the biasing force provided by the biasing member 34 on the striker cable cam 32. As the actuation cable 26 moves in the first direction, the striker cable cam 32 and thus also the striker pin 30 rotate about the striker axis S_{A} to pivot the foldable striker 28 from the deployed position (FIG. 4) to the folded position (FIG. 8). The legs 38 of the foldable striker 28, which are coupled to the striker pin 30, follow a profile of the striker cable cam 32 to pivot the foldable striker 28 to the folded position. When the closure module 12 is moved from the open position to the closed position, the actuation cable 26 is released, and the biasing force of the biasing member 34 returns the foldable striker 28 to the deployed position, so that the foldable striker 28 can engage the latch mechanism 16 to hold the closure module 12 in the closed position.

As discussed above, the biasing member 34 can be reversed to bias the foldable striker 28 to the folded position when the closure module 12 is moved to the open position. In this configuration, when the closure module 12 is moved from the open position to the closed position, the actuation cable 26 moves in the first direction to cause the foldable striker 28 to pivot from the folded position to the deployed position.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle assembly, comprising:
a striker assembly including a foldable striker that pivots about a striker axis from a deployed position to a folded position in response to movement of a closure module from a closed position to an open position.

2. The vehicle assembly of claim 1, further comprising a biasing member that biases the foldable striker to the deployed position.

3. The vehicle assembly of claim 1, further comprising an actuation cable configured to move the foldable striker from the deployed position to the folded position in response to the closure module moving from the closed position to the open position.

4. The vehicle assembly of claim 3, further comprising a striker cable cam, the actuation cable coupled to the striker assembly through the striker cable cam.

5. The vehicle assembly of claim 4, wherein the striker cable cam includes a body that rotates about the striker axis, and a stop that projects radially outward from the body, the stop configured to block rotation of the foldable striker past the deployed position.

6. The vehicle assembly of claim 4, further comprising a hinge assembly including a hinge cable cam, wherein a first end of the actuation cable is coupled to the striker cable cam and an opposite, second end of the actuation cable is coupled to the hinge cable cam.

7. The vehicle assembly of claim 6, wherein the hinge assembly includes an upper hinge and a lower hinge that pivot about a hinge axis, and the hinge cable cam includes a body and a post that projects laterally from the body and connects the upper hinge and the lower hinge, the post secured to the upper hinge such that the hinge cable cam pivots with the upper hinge about the hinge axis.

8. The vehicle assembly of claim 7, further comprising the closure module, wherein the hinge cable cam rotates about the hinge axis to move the actuation cable in a first direction to cause the foldable striker to pivot from the deployed position to the folded position when the closure module moves from the closed position to the open position.

9. The vehicle assembly of claim 8, wherein, when the foldable striker is in the deployed position, the foldable striker extends perpendicularly away from the closure module, and when the foldable striker is in the folded position, the foldable striker is folded against the closure module.

10. The vehicle assembly of claim 8, wherein the closure module is a hood.

11. A vehicle assembly, comprising:
a closure module of a vehicle, the closure module moveable between a closed position and an open position;
a striker assembly secured to the closure module at a first location, the striker assembly including a foldable striker that pivots about a striker axis from a deployed position to a folded position when the closure module moves from the closed position to the open position;
a hinge assembly secured to the closure module at a second location; and
an actuation cable that operably couples the striker assembly to the hinge assembly.

12. The vehicle assembly of claim 11, wherein, when the closure module is moved from the closed position to the open position, the hinge assembly moves the actuation cable in a first direction to cause the foldable striker to pivot from the deployed position to the folded position.

13. The vehicle assembly of claim 11, further comprising a biasing member that biases the foldable striker from the folded position to the deployed position when the closure module is moved from the open position to the closed position.

14. The vehicle assembly of claim 11, wherein the striker assembly includes a striker cable cam that is coupled to the actuation cable.

15. The vehicle assembly of claim 11, wherein the hinge assembly includes an upper hinge that is secured at the second location to the closure module, a lower hinge that is secured to a body side panel of the vehicle, and a hinge cable cam that pivots about a hinge axis and connects the upper hinge and the lower hinge.

16. The vehicle assembly of claim 15, wherein the hinge cable cam is coupled to the actuation cable.

17. A vehicle striker actuation method, comprising:
folding a foldable striker of a striker assembly in response to moving a closure module of a vehicle from a closed position to an open position.

18. The method of claim 17, wherein moving the closure module from the closed position to the open position moves an actuation cable in a first direction to cause the foldable striker to pivot from a deployed position to a folded position.

19. The method of claim 18, further comprising biasing the foldable striker to cause the foldable striker to pivot from the folded position to the deployed position in response to moving the closure module from the open position to the closed position.

20. The method of claim 17, wherein the closure module is a hood.
